(19) United States
(12) Patent Application Publication
(10) Pub. No.: US 2016/0283518 A1
(43) Pub. Date: Sep. 29, 2016

(54) METHOD, APPARATUS, AND COMPUTER-READABLE MEDIUM FOR DETERMINING A LOCATION ASSOCIATED WITH UNSTRUCTURED DATA

(71) Applicant: GEOGRAPHIC SERVICES, INC., Mclean, VA (US)

(72) Inventors: ALEX TARANENKO, SILVER SPRING, MD (US); KEYVAN RAFEI, GREAT FALLS, VA (US)

(21) Appl. No.: 15/082,709

(22) Filed: Mar. 28, 2016

Related U.S. Application Data
(60) Provisional application No. 62/139,602, filed on Mar. 27, 2015.

(51) Int. Cl. G06F 17/30

(52) U.S. Cl. CPC G06F 17/30241; G06F 17/3087; G06F 17/30675; G06F 17/30722

(57) ABSTRACT

A method, apparatus, and computer-readable medium for determining a location associated with unstructured data, including receiving unstructured data from a source of information, identifying an association between information in the unstructured data and a data object in a geospatial database, wherein the geospatial database comprises one or more classes and the data object is an object in at least one of the one or more classes, and associating a location with the unstructured data based at least in part on the data object.

### RELATED APPLICATIONS

This application claims priority to U.S. Provisional Application No. 62/139,602, filed Mar. 27, 2015 and is a continuation-in-part of U.S. Non-Provisional Application No. 14/210,283, filed Mar. 13, 2014, titled “METHOD, APPARATUS, AND COMPUTER-READABLE MEDIUM FOR CONTEXTUAL DATA MINING” (hereinafter “Contextual Data-Mining Non-Provisional Application”), which itself claims priority to U.S. Provisional Application No. 61/780,871, filed Mar. 13, 2013, titled “HUMAN TERRAIN FEATURE EXTRACTION” (hereinafter “Human Terrain Provisional Application”), the disclosures of which are hereby incorporated by reference in their entirety.

### BRIEF DESCRIPTION OF THE DRAWINGS

FIG. 1 illustrates a flowchart for determining a location associated with unstructured data according to an exemplary embodiment.

FIG. 2 illustrates dense network of black dots (groups of polygons), which represent the dense network of federation, tribe, clan, and family information in Iraq and Syria.

FIG. 3 illustrates a flowchart for identifying an association between information in the unstructured data and a data object in a geospatial database according to an exemplary embodiment.

FIG. 4 illustrates an example of a Tweet 402 that falls within the polygons 401 corresponding to a particular social group data object that covers the area around the town of Al Khālidīyah.

FIG. 5 illustrates another possible aspect of the polygons corresponding to a particular data object, such as a social group data object.

FIG. 6 illustrates flowchart for identifying an association between information in the unstructured data and a data object in a geospatial database when geographic areas include probability zones according to an exemplary embodiment.

FIG. 7 illustrates the various polygons groups and highlights (with white dots) the federations of Dulaym and Zubayd.

FIG. 8 illustrates the various polygons groups and highlights (also in white) the family groups making up the Dulaym tribe in Iraq and Syria.

FIG. 9 illustrates a method for identifying one or more second locations corresponding to the unstructured data.

FIG. 10 illustrates various polygon groups and associated buffers (probability zones) to geospatially represent the human footprint within a named location and establish relational links to other polygons in same or different locations based on related content.

FIG. 11 illustrates different hierarchical levels of geospatial data corresponding to different social groups.

FIG. 12 illustrates a linking of Sajidah to the Ar Rishawi family of Al Khalidiyah in the human geography data model.

FIG. 13 illustrates a generalized example of a computing environment that can be used to implement the methods and systems described herein.

### DESCRIPTION

Geospatially enabled social media provide coordinates but no location names for identified content. By contrast, the present system and method utilizes a Human Geography dataset for data mining purposes in which the polygons of hierarchical societal organizations allow GPS enabled coordinates of social media to be automatically linked to named geographic locations and associated groups and individuals within that polygon footprint. Additionally, the extended hierarchical relationships can be extended to related polygons. For example, if a named individual from a family group tied to a location has a Twitter account that is not GPS enabled, they can be linked to a location of a related family member or group, providing location information for both the individual and the related family member or group.

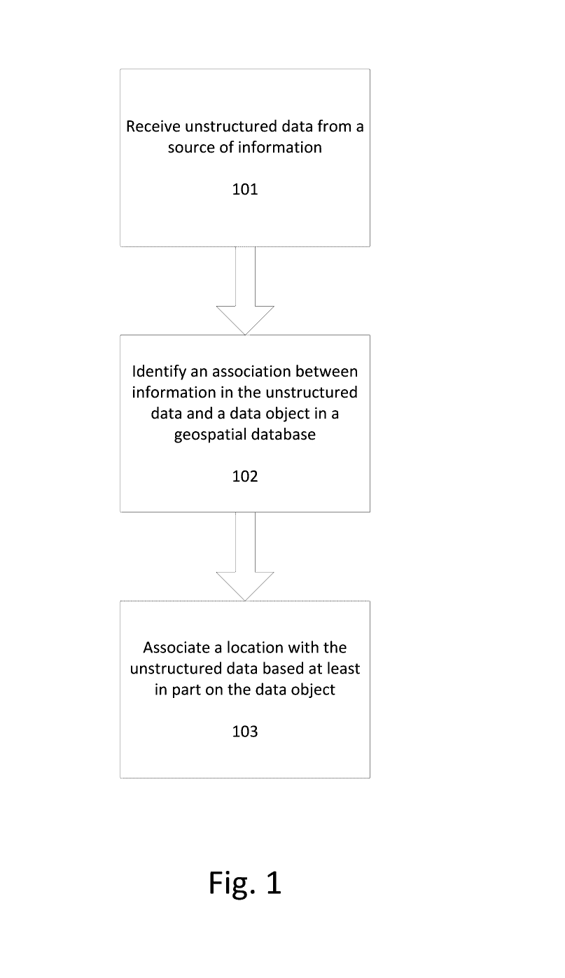

FIG. 1 illustrates a flowchart for determining a location associated with unstructured data according to an exemplary embodiment. At step 101 unstructured data from a source of information is received. The source of information can include any web or content source, such as a website, a blog, a server, a repository, and/or a database. The unstructured data can be received from a web search, web scraping software, data mining software, analytics vendors, and/or from big data servers.

Unstructured data, as used herein, does not require that the data have no structure (as nearly all data adheres to some type of structure), but means that the data is not required to be any predefined format. The unstructured data can include the content of website, a social media post such as a Facebook post, a Twitter tweet, a document, an electronic message, a video, and/or an image. For example, step 101 can include receiving a Twitter tweet which includes a message.

At step 102, an association between information in the unstructured data and a data object in a geospatial database is identified. The geospatial database can include one or more classes and the data object can be an object in at least one of the one or more classes. The classes that can be part of the geospatial database and related objects are described in greater detail in the Human Terrain Provisional Application and the Contextual Data-Mining Non-Provisional Application.

The geospatial database can be implemented as any type of database or relational database, such as a geodatabase/spatial database, a graph database, and/or an object oriented database.

For example, the geospatial database can be implemented as a relational geodatabase or spatial database which allows for representation of geometric objects such as points, lines and polygons, 3D objects, topological coverages. The relational geodatabase or spatial database can include operations for spatial measurements such as computing line length, polygon area, the distance between geometries, etc. The relational geodatabase or spatial database can also include operations for spatial functions such as modifying existing features to create new features, intersecting features, etc. and can support functions for spatial predicates for true/false queries about spatial relationships, geometry constructors for creating new geometries, and observer functions to support queries which return specific information about a feature in the database.

Additionally, the geospatial database can be implemented as a graph database which could have the same functionality from a user perspective as the relational geodatabase or spatial database but which can have a different underlying structure. For example, the graph database can utilize nodes, edges, and properties to represent and store the data that would be represented and stored in objects and classes in a relational geodatabase or spatial database. In this case, classes, objects within those classes, and/or relationships between classes would be represented as one or more of nodes, edges, and/or properties within the graph database.

The geospatial database can also be implemented as an object-oriented database or an object-relational database (a combination of an object-oriented database and a relational database). The object-oriented database or object-relational database could have the same functionality from a user perspective as the relational geodatabase or spatial database but which can have a different underlying structure. For example, the object-oriented database or object-relational database can utilize custom data objects and classes created by programmers or engineers to store and represent geospatial data and relationships within the geospatial data.

Although the present application describes the geospatial database in terms of one classes and data objects within the classes, it is understood that these classes and data objects can be represented and/or stored in a variety of possible forms in the underlying database, which can be one or more (or a combination) of a relational database, a spatial database, a geodatabase, a relational geodatabase, a graph database, an object oriented database, an object-relational database, or any other database structure.

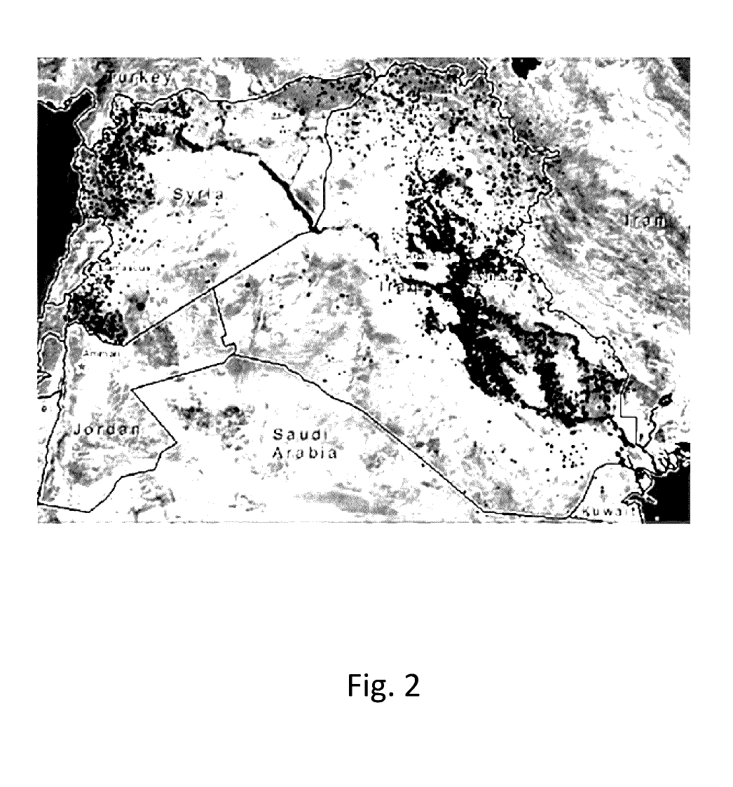

The classes in the geospatial database can include social group classes which can be defined as (or correspond to) areas on a map. These social group classes can include a plurality of data objects which correspond to different geographic areas of a map, with the geographic areas being defined by a plurality of polygons. For example, FIG. 2 illustrates dense network of black dots (groups of polygons), which represent the dense network of federation, tribe, clan, and family information in Iraq and Syria. Each group of polygons contains rich human geography (HG) relational data and each group of polygons is also linked to other groups of polygons. These interrelationships form the basis for the society's hierarchy, from family unit through clan and tribe to federation.

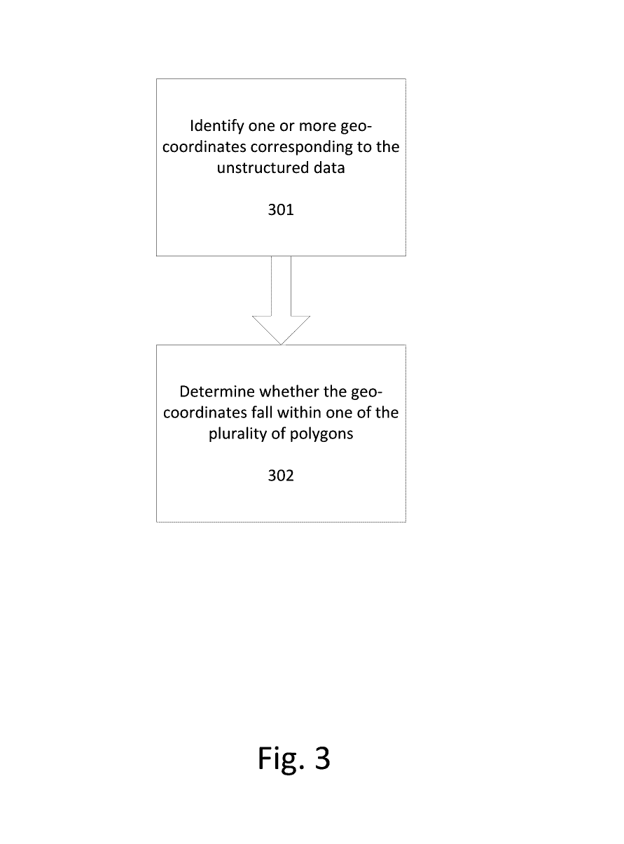

FIG. 3 illustrates a flowchart for identifying an association between information in the unstructured data and a data object in a geospatial database according to an exemplary embodiment. At step 301 one or more geo-coordinates corresponding to the unstructured data are identified. For example, if the unstructured data is a social media post or a Tweet, it will frequently include geotags specifying location coordinates. Step 301 can include identifying one or more geo-tags associated with the unstructured data and determining the geo-coordinates from the geotags.

At step 302 it is determined whether the geo-coordinates fall within one of the plurality of polygons. An association can be identified between information in the unstructured data and a social group data object corresponding to a geographic area of a map if the geo-coordinates corresponding to the unstructured data fall within one of the plurality of polygons corresponding to the social group data object.

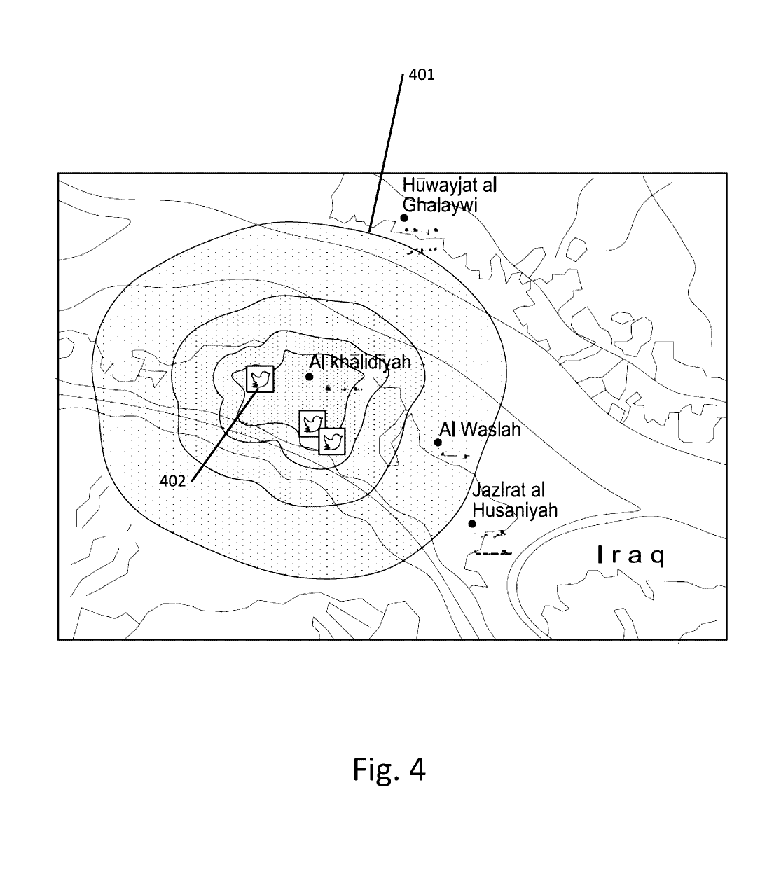

For example, FIG. 4 illustrates an example of a Tweet 402 that falls within the polygons 401 corresponding to a particular social group data object that covers the area around the town of Al Khālidīyah.

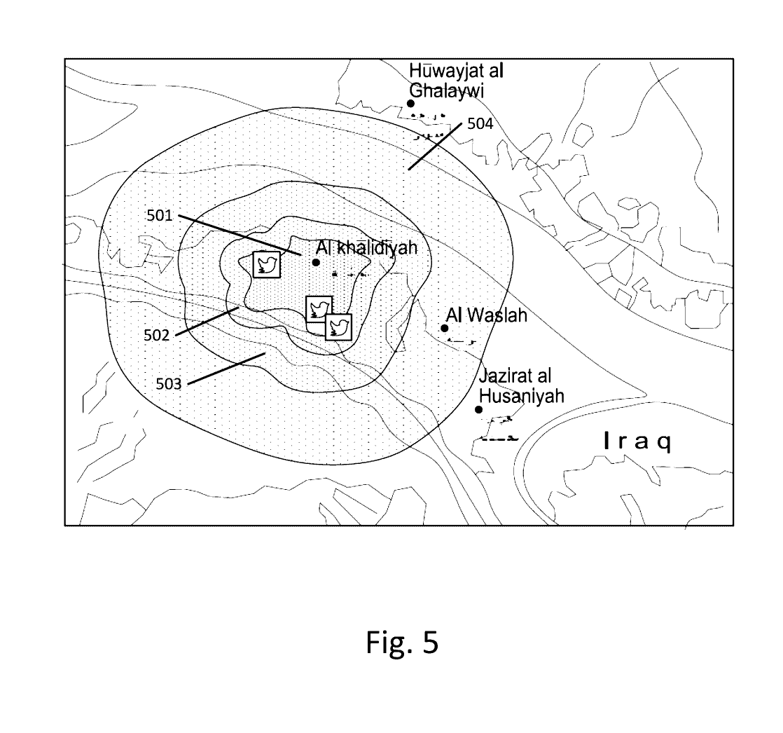

FIG. 5 illustrates another possible aspect of the polygons corresponding to a particular data object, such as a social group data object. As shown in FIG. 5, the polygons defining a particular geographic location which corresponds social group data object can be divided into a plurality of zones, such as zones 501, 502, 503, and 504. Each of these zones are probability zones and each probability zone indicates the probability that polygons within that zone are associated with the geographic area of the map. For example, polygons within inner zone 501 can have a 90% chance of being associated with the town of Al Khālidīyah, polygons within zone 502 can have a 75% chance of being associated with the town of Al Khālidīyah, polygons within zone 503 can have a 50% chance of being associated with the town of Al Khālidīyah, and polygons within zone 504 can have a 25% chance of being associated with the town of Al Khālidīyah. Of course, these percentages are provided for illustration only, and many variations are possible.

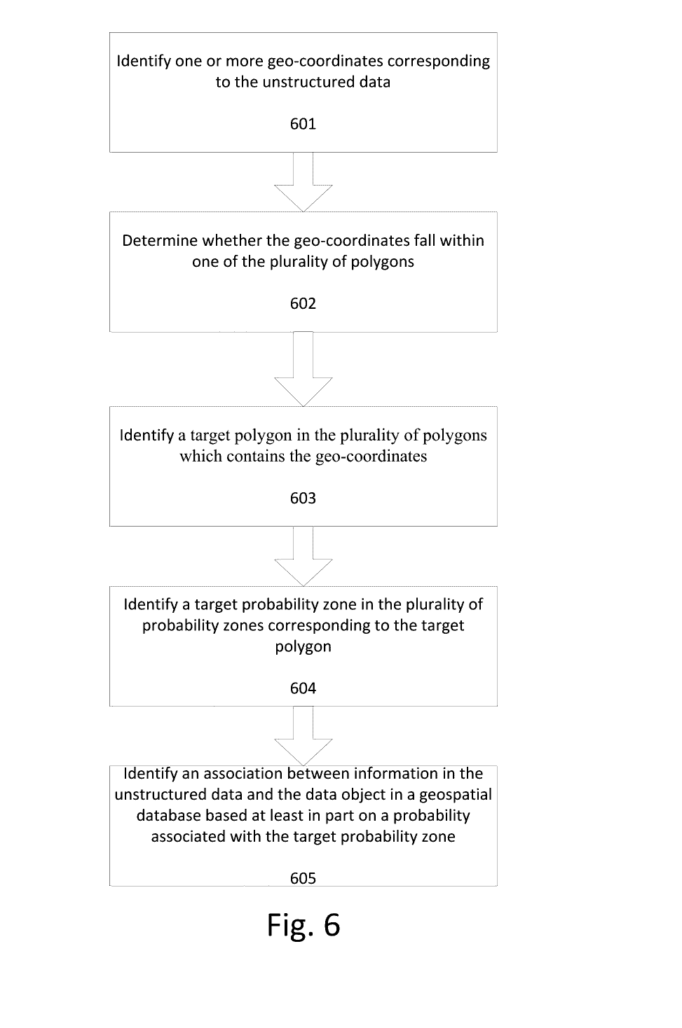

FIG. 6 illustrates flowchart for identifying an association between information in the unstructured data and a data object in a geospatial database when geographic areas include probability zones according to an exemplary embodiment. At step 601 one or more geo-coordinates corresponding to the unstructured data are identified. For example, if the unstructured data is a social media post or a Tweet, it will frequently include geotags specifying location coordinates. Step 601 can include identifying one or more geo-tags associated with the unstructured data and determining the geo-coordinates from the geotags.

At step 602 it is determined whether the geo-coordinates fall within one of the plurality of polygons. At step 603 a target polygon in the plurality of polygons which contains the geo-coordinates can be identified based at least in part on a determination that the geo-coordinates fall within one of the plurality of polygons. Steps 602 and 603 can be a single step (in which the target polygon is identified as a part of the determination of step 602).

At step 604 a target probability zone in the plurality of probability zones is identified which corresponds to the target polygon. This can be performed by cross referencing the target polygon with some mapping table or data structure which stores the probability for that polygon. Such structures are described in greater detail in the Human Terrain Provisional Application as buffer zones.

At step 605 an association between information in the unstructured data and the social group data object in a geospatial database based at least in part on a probability associated with the target probability zone. For example, an association can be identified between information in the unstructured data and a social group data object corresponding to a geographic area of a map if the geo-coordinates corresponding to the unstructured data fall within one of the plurality of polygons corresponding to the social group data object and that polygon is part of a target probability zone having at least 50% probability.

Alternatively, the system can identify different levels of association reflecting the possible probabilities corresponding to the different probability zones. For example, if the target polygon which contains the geo-coordinates corresponding to the unstructured data is in a probability zone having 90% probability of associated with a geographic area of the map, a strong association between the unstructured data and the social group data object corresponding to the geographic area of a map can be identified. If the target polygon which contains the geo-coordinates corresponding to the unstructured data is in a probability zone having 50% probability of associated with a geographic area of the map, a medium association between the unstructured data and the social group data object corresponding to the geographic area of a map can be identified. If the target polygon which contains the geo-coordinates corresponding to the unstructured data is in a probability zone having 20% probability of associated with a geographic area of the map, a weak association between the unstructured data and the social group data object corresponding to the geographic area of a map can be identified.

Identifying an association between information in the unstructured data and the data object in a geospatial database can include identifying an association between information in the unstructured data and a person data object in the geospatial database, wherein the person data object is associated with a social group data object in the geospatial database, the social group data object corresponding to a geographic area of a map.

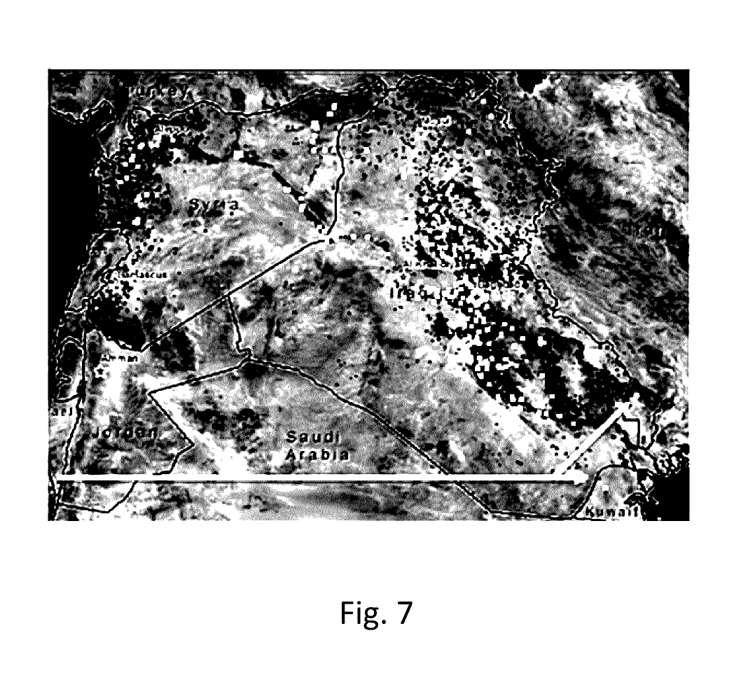

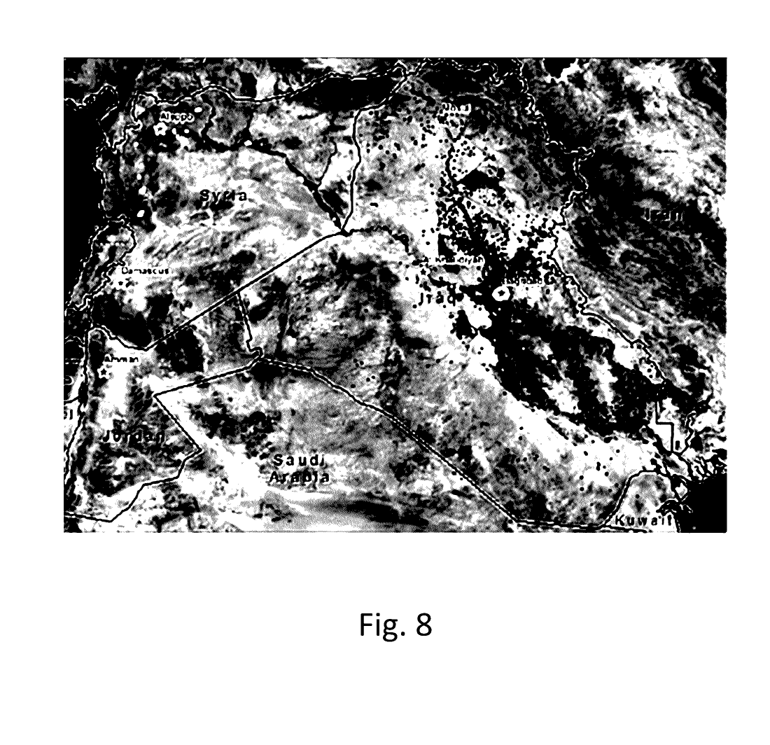

For example, if the unstructured data is a social media post, the person data object can be a data object corresponding to the author of the post, or a family member of the author of the post. This person data object can be part of, connected to, or otherwise associated with a social group data object which corresponds to a geographic area of a map in the HG database. The social group data object can be at any of a plurality of hierarchical levels, such as federation, tribe, clan, and/or family, which are described in greater detail in the Human Terrain Provisional Application and the Contextual Data-Mining Non-Provisional Application. FIG. 7 illustrates the various polygons groups and highlights (with white dots) the federations of Dulaym and Zubayd. These two federations are related through a tribal relationship with the Dulaym tribe in both Iraq and Syria. These federations are related through the Dulaym tribe. To put this in context, the Dulaym tribe dispersed across the region during Ottoman rule as a result of violent clashes over taxes. This Dulaym tribe is the link between the two Federations. Note the geographic reach of the human geography. Groups within these federations extend to Kuwait and Iran, too. Tribal, Clan, and Familial relationships are borderless and can influence or impact distant areas beyond a localized event. The white arrow indicates the cross-border ties to hierarchical relationships in Kuwait and Iran. FIG. 8 illustrates the various polygons groups and highlights (also in white) the family groups making up the Dulaym tribe in Iraq and Syria. Of course, various colors can be used for highlighting groups and white is used in these examples for the purposes of clarity only.

Returning to FIG. 1, at step 103 a location is associated with the unstructured data based at least in part on the data object. When the data object is a social group data object, step 103 can include associating the geographic area corresponding to the social data object with the unstructured data. For example, the tweets 402 shown in FIG. 4 would be associated with the town of Al Khālidīyah.

When the data object is a person data object, step 103 can include associating the geographic area corresponding to a social group data object that is associated with the person data object with the unstructured data. For example, if the unstructured data is a social media post but does not include any geotags, then the unstructured data can be connected with a person data object corresponding to the author, family member of the author, or a member of the same social group as the author. The person data object can then be used to identify the relevant social group data object and the geographic area corresponding to the social group data object can be associated with the social media post.

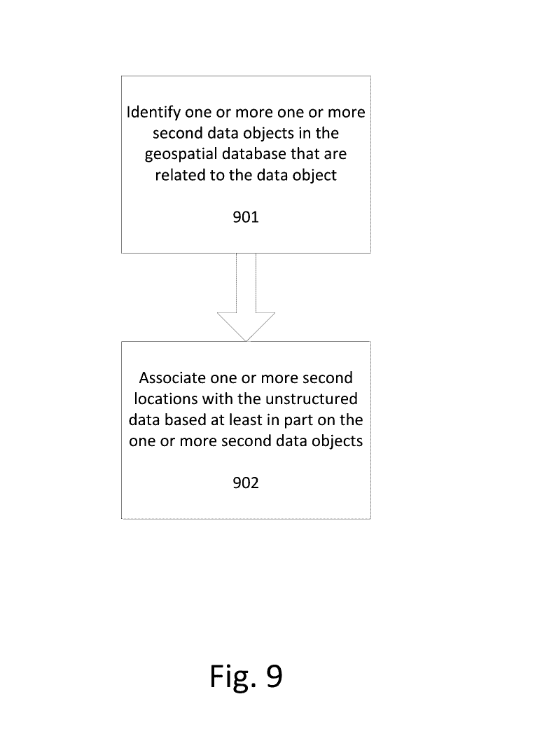

FIG. 9 illustrates a method for identifying one or more second locations corresponding to the unstructured data. At step one or more second data objects in the geospatial database that are related to the data object are identified.

At step 902 one or more second locations are associated with the unstructured data based at least in part on the one or more second data objects. The one or more second data objects can belong to a different class than the data object, and the determination that the one or more second data objects are related to the data object can be made based on an analysis of a relationship class which defines hierarchical relationships (such as social hierarchies) between the one or more classes. The relationship class is discussed in greater detail in the Human Terrain Provisional Application and the Contextual Data-Mining Non-Provisional Application.

When the unstructured data relates to an event, the system can utilize location information of the event to associate the unstructured data with a particular geographic. For example, the one or more classes can include a social group class representing a social group which is defined as a first area on a map. When the information in the unstructured data relates to an event and the data object is a data object in the social group class, an association can be identified by determining, whether the event occurred in a geographic area that is within the first area.

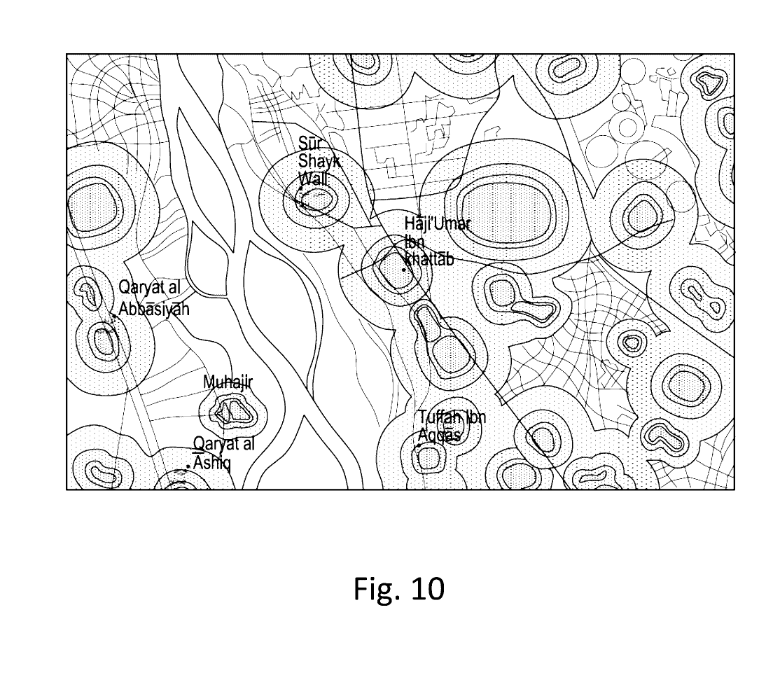

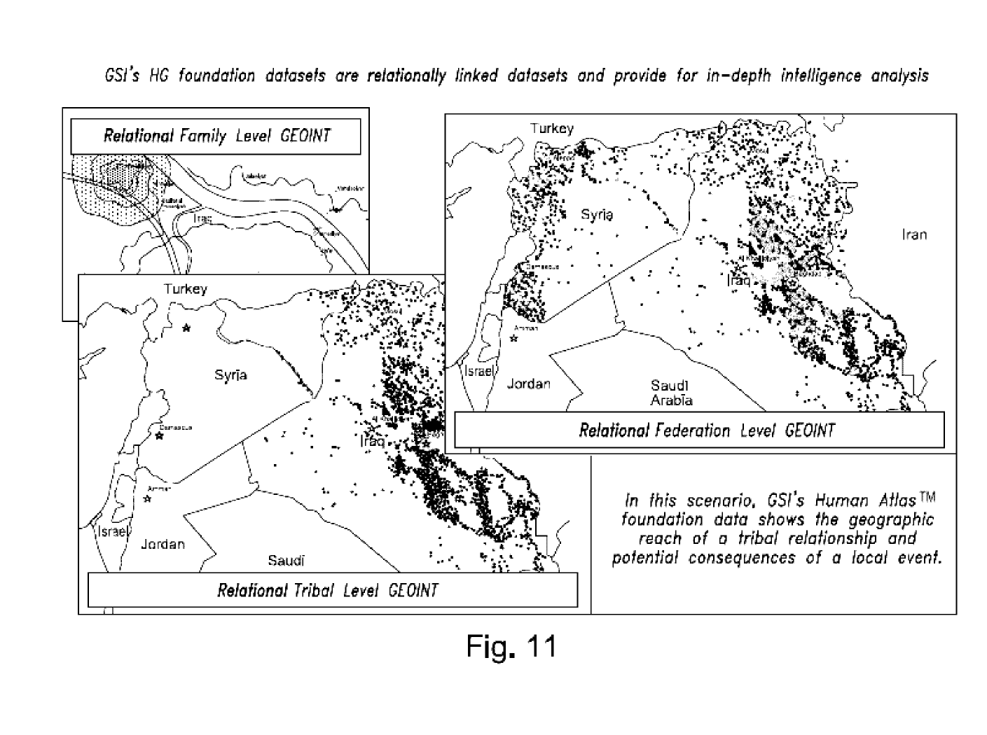

The one or more classes can also include a first social group class representing a first social group which is defined as a first area on a map and a second social group class representing a second social group which is defined as a second area on the map. For example, FIG. 10 illustrates various polygon groups and associated buffers (probability zones) to geospatially represent the human footprint within a named location and establish relational links to other polygons in same or different locations based on related content. Virtually all societies and organizations have hierarchical structures. The data model described herein is a geospatial representation of relational hierarchal social structures used for computation, analysis, search, retrieval, presentation, and dissemination of digital and non-digital content. For example, FIG. 11 illustrates different hierarchical levels of geospatial data corresponding to different social groups.

Operation of the disclosed system and method can be further described with a use case on Sajidah ar Rishawi. In 2005, she and her husband entered into the Amman Radisson Hotel to carry out a suicide bombing. She had trouble detonating her belt, so her husband pushed her out of the room and then took his own life and those of 38 other people. The Jordanian military detained her and sentenced her to death in September 2006. Nearly a decade later, her sentence was carried out in retaliation for the burning alive of Jordanian Air Force Pilot by the Islamic State.

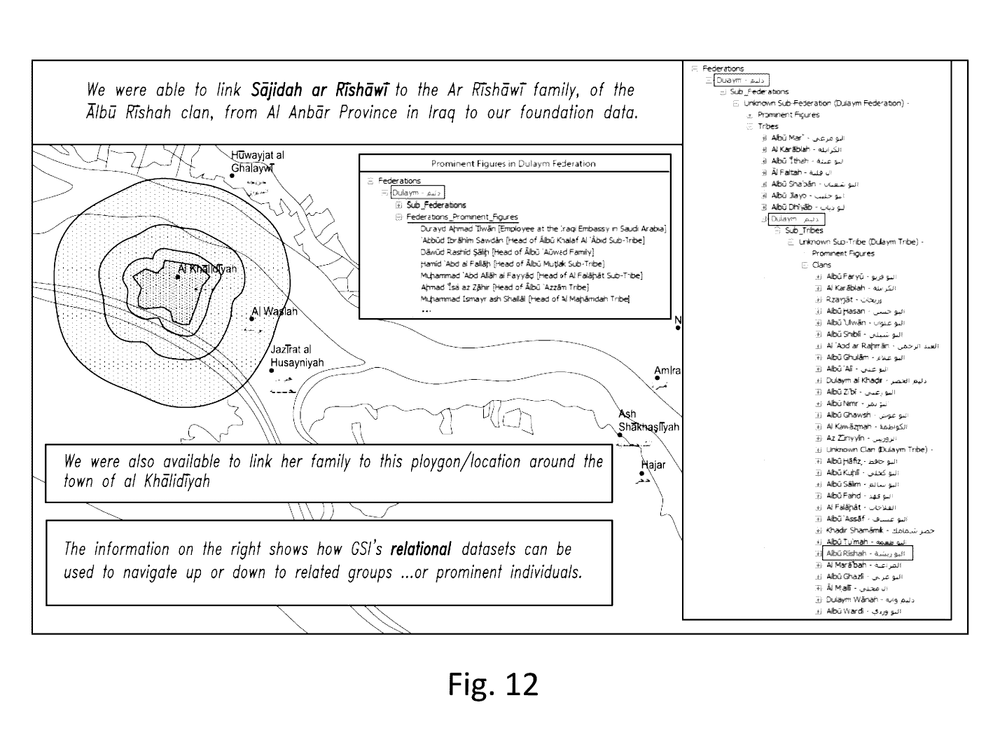

As shown in FIG. 12, the present systems and methods can be used to link Sajidah to the Ar Rishawi family of Al Khalidiyah in the human geography data model (using open source information). This family is a member of the Albu Rishah clan. The data tables represent the ease with which users can navigate up and down the socio-cultural hierarchy. It also includes prominent individuals. Because human geography is a series of relational—or interrelated—links, we can see the extended relationships of Sajidah's family to the tribe and, ultimately, federation. The geospatial enablement of the data represents the geographic span of these relationships. A localized event can have far reaching effects—visualized by the geographic footprint of the tribal and federation relationship.

The present systems and methods can be used a tool to understanding events in a geospatial and geopolitical context. Local publications have theorized that the Islamic State killed the Jordanian AF pilot to galvanize support across Sadijah's extended tribal relationships. By using the Human Geography database and the methods and systems disclosed herein, a user can understand the calculus behind the execution of the Jordanian AF pilot by the Islamic State. In particular: kill the Air Force pilot and Jordan will react by killing Sajidah. Her death will bring together a federation known for its split loyalties to extremist groups. The Islamic State will benefit from the newly aligned Federations against government authorities in the region.

The present systems and methods demonstrates how a localized event in Jordan (her death) can have far-reaching consequences because of the extended socio-cultural relationships throughout Iraq and Syria. By pairing the relational data models, which serve as filters, with big data and web-scraping technologies, the present systems and methods drive a more efficient search process, empowering users to discover previously unknown relationships, and uncover relevant content. This supports dynamic updates for tactical requirements, and anticipatory analysis capabilities.

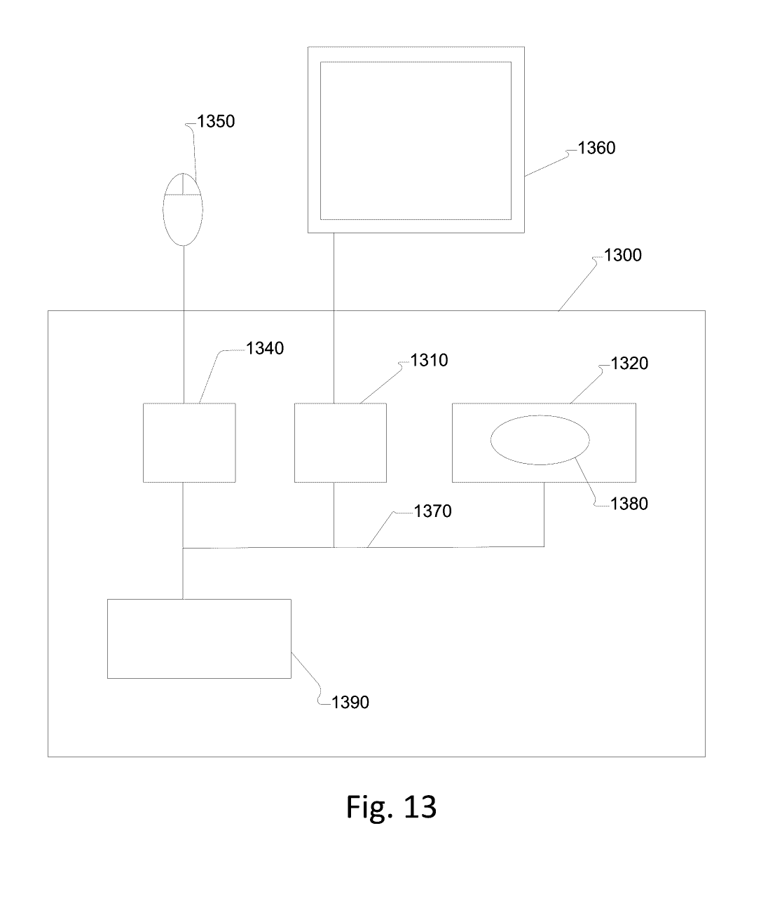

FIG. 13 illustrates a generalized example of a computing environment 1300 that can be used to implement the methods and systems described herein. The computing environment 1300 is not intended to suggest any limitation as to scope of use or functionality of a described embodiment.

With reference to FIG. 13, the computing environment 1300 includes at least one processing unit 1310 and memory 1320. The processing unit 1310 executes computer-executable instructions and can be a real or a virtual processor. In a multi-processing system, multiple processing units execute computer-executable instructions to increase processing power. The memory 1320 can be volatile memory (e.g., registers, cache, RAM), non-volatile memory (e.g., ROM, EEPROM, flash memory, etc.), or some combination of the two. The memory 1320 can store software instructions 1380 for implementing the described techniques when executed by one or more processors. Memory 1320 can be one memory device or multiple memory devices.

A computing environment can have additional features. For example, the computing environment 1300 includes storage 1340, one or more input devices 1350, one or more output devices 1360, and one or more communication connections 1390. An interconnection mechanism 1370, such as a bus, controller, or network interconnects the components of the computing environment 1300. Typically, operating system software or firmware (not shown) provides an operating environment for other software executing in the computing environment 1300, and coordinates activities of the components of the computing environment 1300.

The storage 1340 can be removable or non-removable, and includes magnetic disks, magnetic tapes or cassettes, CD-ROMs, CD-RWs, DVDs, or any other medium which can be used to store information and which can be accessed within the computing environment 1300. The storage 1340 can store instructions for the software 1380.

The input device(s) 1350 can be a touch input device such as a keyboard, mouse, pen, trackball, touch screen, or game controller, a voice input device, a scanning device, a digital camera, remote control, or another device that provides input to the computing environment 1300. The output device(s) 1360 can be a display, television, monitor, printer, speaker, or another device that provides output from the computing environment 1300.

The communication connection(s) 1390 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1300, computer-readable media include memory 1320, storage 1340, communication media, and combinations of any of the above.

Of course, FIG. 13 illustrates computing environment 1300, display device 1360, and input device 1350 as separate devices for ease of identification only. Computing environment 1300, display device 1360, and input device 1350 can be separate devices (e.g., a personal computer connected by wires to a monitor and mouse), can be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1300 can be a set-top box, mobile device, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments can be used with or perform operations in accordance with the teachings described herein. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

What is claimed is:

1. A method executed by one or computing devices for determining a location associated with unstructured data, the method comprising:
receiving, by at least one of the one or more computing devices, unstructured data from a source of information;
identifying, by at least one of the one or more computing devices, an association between information in the unstructured data and a data object in a geospatial database, wherein the geospatial database comprises one or more classes and the data object is an object in at least one of the one or more classes; and
associating, by at least one of the one or more computing devices, a location with the unstructured data based at least in part on the data object.

2. The method of claim 1, wherein the unstructured data comprises one or more of a website, a social media post, a tweet, an electronic message, a video, and an image.

3. The method of claim 1, wherein the data object comprises a social group data object corresponding to a geographic area of a map.

4. The method of claim 3, wherein the geographic area is defined by a plurality of polygons.

5. The method of claim 4, wherein identifying an association between information in the unstructured data and the data object in a geospatial database comprises:
identifying one or more geo-coordinates corresponding to the unstructured data; and
determining whether the geo-coordinates fall within one of the plurality of polygons.

6. The method of claim 5, wherein identifying one or more geo-coordinates corresponding to the unstructured data comprises:
identifying one or more geo-tags associated with the unstructured data.

7. The method of claim 4, wherein the plurality of polygons are divided into a plurality of probability zones and wherein each probability zone indicates the probability that polygons within that zone are associated with the geographic area of the map.

8. The method of claim 7, wherein identifying an association between information in the unstructured data and the data object in a geospatial database comprises:
identifying one or more geo-coordinates corresponding to the unstructured data;
determining whether the geo-coordinates fall within one of the plurality of polygons;
identifying a target polygon in the plurality of polygons which contains the geo-coordinates based at least in part on a determination that the geo-coordinates fall within one of the plurality of polygons;
identifying a target probability zone in the plurality of probability zones corresponding to the target polygon; and
identifying an association between information in the unstructured data and the social group data object in a geospatial database based at least in part on a probability associated with the target probability zone.

9. The method of claim 3, wherein associating a location with the unstructured data based at least in part on the data object comprises:
associating the geographic area corresponding to the social group data object with the unstructured data.

10. The method of claim 1, wherein identifying an association between information in the unstructured data and the data object in a geospatial database comprises:
identifying an association between information in the unstructured data and a person data object in the geospatial database, wherein the person data object is associated with a social group data object in the geospatial database, the social group data object corresponding to a geographic area of a map.

11. The method of claim 10, wherein associating a location with the unstructured data based at least in part on the data object comprises:
associating the geographic area corresponding to the social group data object with the unstructured data.

12. The method of claim 1, further comprising:
identifying, by at least one of the one or more computing devices, one or more second data objects in the geospatial database that are related to the data object; and
associating, by at least one of the one or more computing devices, one or more second locations with the unstructured data based at least in part on the one or more second data objects.

13. The method of claim 12, wherein the one or more second data objects belong to a different class than the data object, and the determination that the one or more second data objects are related to the data object is made based on an analysis of a relationship class which defines hierarchical relationships between the one or more classes.

14. The method of claim 12, wherein the one or more classes include a social group class representing a social group which is defined as a first area on a map.

15. The method of claim 14, wherein the information in the unstructured data relates to an event, the data object is a data object in the social group class, and wherein identifying an association comprises:
determining, by at least one of the one or more computing devices, whether the event occurred in a geographic area that is within the first area.

16. The method of claim 12, wherein the one or more classes include a first social group class representing a first social group which is defined as a first area on a map and a second social group class representing a second social group which is defined as a second area on the map.

17. A system for determining a location associated with unstructured data, the system comprising:
one or more processors; and
one or more memories operatively coupled to at least one of the one or more processors and having instructions stored thereon that, when executed by at least one of the one or more processors, cause at least one of the one or more processors to:
receive unstructured data from a source of information;
identify an association between information in the unstructured data and a data object in a geospatial database, wherein the geospatial database comprises one or more classes and the data object is an object in at least one of the one or more classes; and
associate a location with the unstructured data based at least in part on the data object.

18. The system of claim 17, wherein the data object comprises a social group data object corresponding to a geographic area of a map, wherein the geographic area is defined by a plurality of polygons, and wherein the instructions that, when executed by at least one of the one or more processors, cause at least one of the one or more processors to identify an association between information in the unstructured data and the data object in a geospatial database further cause at least one of the one or more processors to:
identify one or more geo-coordinates corresponding to the unstructured data; and
determine whether the geo-coordinates fall within one of the plurality of polygons.

19. At least one non-transitory computer-readable medium storing computer-readable instructions that, when executed by one or more computing devices, cause at least one of the one or more computing devices to:
receive unstructured data from a source of information;
identify an association between information in the unstructured data and a data object in a geospatial database, wherein the geospatial database comprises one or more classes and the data object is an object in at least one of the one or more classes; and
associate a location with the unstructured data based at least in part on the data object.

20. The at least one non-transitory computer-readable medium of claim 19, wherein the data object comprises a social group data object corresponding to a geographic area of a map, wherein the geographic area is defined by a plurality of polygons, and wherein the instructions that, when executed by at least one of the one or more computing devices, cause at least one of the one or more computing devices to identify an association between information in the unstructured data and the data object in a geospatial database further cause at least one of the one or more computing devices to:
identify one or more geo-coordinates corresponding to the unstructured data; and
determine whether the geo-coordinates fall within one of the plurality of polygons.
